(19) United States
(12) Patent Application Publication
(10) Pub. No.: US 2013/0245954 A1
(43) Pub. Date: Sep. 19, 2013

(54) SEISMIC IMAGING SYSTEM USING COSINE TRANSFORM IN LOGARITHMIC AXIS

(71) Applicant: Changsoo SHIN, Seoul (KR)

(72) Inventor: Changsoo SHIN, Seoul (KR)

(73) Assignee: Seoul National University R&DB Foundation, Seoul (KR)

(21) Appl. No.: 13/799,739

(22) Filed: Mar. 13, 2013

Related U.S. Application Data
(60) Provisional application No. 61/610,074, filed on Mar. 13, 2012.
(60) Provisional application No. 61/610,078, filed on Mar. 13, 2012.
(60) Provisional application No. 61/610,082, filed on Mar. 13, 2012.

(51) Int. Cl. G01V 1/00

(52) U.S. Cl. CPC G01V 1/003
USPC 702/14

(57) ABSTRACT

Provided is seismic imaging, particularly, a seismic imaging system. The seismic imaging system includes a measured data processing unit converting measured data from receiver to cosine transformed data in logarithmic scale axes, a subsurface structure estimating unit calculating subsurface modeling parameters with measured data transformed in the measured data processing unit based on a cosine transformed acoustic waveform equation defined along logarithmic axes, and an image output unit converting modeling parameters calculated in the subsurface structure estimating unit and outputting the converted image data.

### CROSS-REFERENCE TO RELATED APPLICATION

This application claims the benefit under 35 U.S.C. §119(a) of a U.S. Provisional Patent Application No. 61/610,074, No. 61/610,078 and No. 61/610,082, all filed on Mar. 13, 2012, the entire disclosures of which are incorporated herein by reference for all purposes.

### BACKGROUND

1. Field

The following description relates to seismic imaging technology.

2. Description of the Related Art

Waveform inversion and reverse time migration are well known in the seismic imaging field. These algorithms are defined based on time or frequency domain. Frequency-domain based algorithms are based on Fourier-transformed measured data and a Fourier-transformed waveform equation. Another waveform inversion and migration algorithms based on Laplace-transformed measured data and a Laplace-transformed waveform equation have been proposed by inventors of the present invention, which enable the estimation of deeper parts of the subsurface with a smaller number of streamers. However, reflected waves still cause artifacts in the imaging output and make the algorithms less efficient.

### SUMMARY

The following description relates to a technique for improving the resolution of reverse-time migration through source estimation.

According to an aspect of embodiment, there is provided a seismic imaging system including: a measured data processing unit converting measured data from receiver to cosine transformed data in logarithmic scale axes; a subsurface structure estimating unit calculating subsurface modeling parameters with measured data transformed in the measured data processing unit based on a cosine transformed acoustic waveform equation defined along logarithmic axes; and an image output unit converting modeling parameters calculated in the subsurface structure estimating unit and outputting the converted image data.

The subsurface structure estimating unit may include a waveform inversion unit updating initial modeling parameters of the cosine transformed acoustic waveform equation defined along logarithmic axes so as to minimize an objective function related to a residual between the measured data calculated in the measured data processing unit and modeling data calculated from a waveform equation with previous modeling parameters.

The waveform inversion unit may include a modeling data calculating unit calculating modeling data to be detected in each of receivers when a waveform propagates through subsurface structure defined by modeling parameters of cosine transformed waveform equation defined along logarithmic scale axes, an objective function calculating unit calculating an objective function related to a residual between measured data processed in the measured data processing unit and modeling data processed in the modeling data computation unit, comparing gradient of the objective function with a predetermined value and outputting the gradient if the gradient is larger than a predefined value and outputting the modeling parameters then if the gradient is smaller than the predefined value, and a modeling parameter updating unit updating modeling parameters to a direction to which the objective function decreases and outputting the result to the modeling data calculating unit.

The subsurface structure estimating unit may include a back-propagation unit configured to back-propagate the measured data based on a modeling parameter of a cosine transformed acoustic waveform equation defined along logarithmic-scaled axes, a virtual source estimator configured to estimate virtual sources, and a convolution unit configured to convolve the back-propagated measured data with the virtual source and to output the results of the convolution.

The seismic imaging system may further include a back-propagation unit configured to back-propagate the measured data based on a modeling parameter of a cosine transformed acoustic waveform equation defined along logarithmic-scaled axes; a virtual source estimator configured to estimate virtual sources; and a convolution unit configured to convolve the back-propagated measured data with the virtual source and to output the results of the convolution.

Other features and aspects will be apparent from the following detailed description, the drawings, and the claims.

### BRIEF DESCRIPTION OF THE DRAWINGS

FIG. 1 is a block diagram illustrating an example of a seismic imaging system according to an exemplary embodiment.

FIG. 2 is a block diagram illustrating an example of a seismic imaging system using waveform inversion according to an exemplary embodiment.

FIG. 3 is a block diagram illustrating an example of a seismic imaging system using reverse-time migration according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

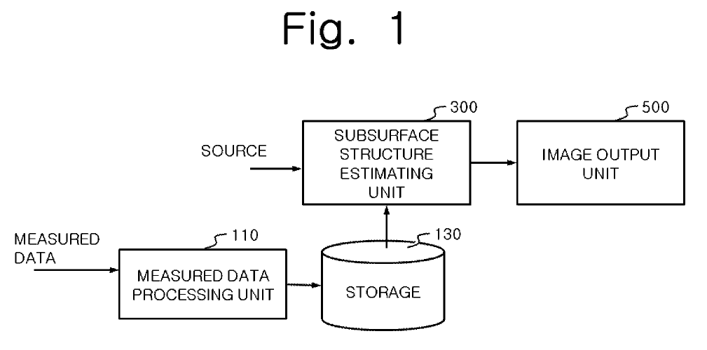

FIG. 1 is a block diagram illustrating an example of a seismic imaging system according to an exemplary embodiment. As illustrated in FIG. 1, the seismic imaging system includes a measured data processing unit 110 to convert measured data from a receiver into cosine transformed data in logarithmic scale axes and a subsurface structure estimating unit 300 to calculate subsurface modeling parameters with measured data transformed in the measured data processing unit, based on a cosine transformed acoustic waveform equation defined along logarithmic axes.

In one example, cosine transform is used as a modeling operator. An x-axis as a propagation direction and a z-axis as a depth direction in a modeling space are transformed into new logarithmic scale X-axis and Z-axis, respectively.

In the embodiment described herein, the modeling domain and operator is different from the original one. Cosine transform is used, instead of Fourier transform. Also, linear scale axis x and z are transformed into new logarithmic scale axis X and Z.

The acoustic wave equation in the time domain can be written as follows:

$$\frac{1}{{c}^{2}} \frac{{\partial }^{2} u ( x , z , t )}{\partial {t}^{2}} = \frac{{\partial }^{2} u ( x , z , t )}{\partial {x}^{2}} + \frac{{\partial }^{2} u ( x , z , t )}{\partial {z}^{2}} + f ( x , z , t ) \qquad ( 1 )$$

where c is the velocity, u is the wavefield in the time domain and f is the source wavelet.

A frequency-domain wave equation may be obtained by applying Cosine transform to the equation (1) as follows:

$$- \frac{{w}^{2}}{{c}^{2}} \tilde{u} ( x , z , t ) = \frac{{\partial }^{2} \tilde{u} ( x , z , t )}{\partial {x}^{2}} + \frac{{\partial }^{2} \tilde{u} ( x , z , t )}{\partial {z}^{2}} + \tilde{f} ( x , z , t ) \\ where \\ \tilde{u} ( x , z , t ) = {\int }_{0}^{∞} u ( x , z , t ) cos ( w t ) d t \\ \tilde{f} ( x , z , t ) = {\int }_{0}^{∞} f ( x , z , t ) cos ( w t ) d t \qquad ( 2 )$$

Also, the x-axis and z-axis are transformed into new axis X and Z. Assuming that the wave propagates along the new axes X (X=g(x)) and Z (Z=h(z)), equation (5) may be defined as follows:

$$- \frac{{w}^{2}}{{c}^{2}} \tilde{u} ( X , Z , t ) = \frac{{\partial }^{2} \tilde{u} ( X , Z , t )}{\partial {x}^{2}} + \frac{{\partial }^{2} \tilde{u} ( X , Z , t )}{\partial {z}^{2}} + \tilde{f} ( X , Z , t ) \qquad ( 3 )$$

In the equation above, the partial derivative with respect to x and z should be replaced as follows:

$$\frac{{\partial }^{2} \tilde{u} ( X , Z , t )}{\partial {x}^{2}} = \frac{{\partial }^{2} u ( X , Z , t )}{\partial {X}^{2}} {( \frac{\partial X}{\partial x} )}^{2} + \frac{{\partial }^{2} u ( X , Z , t )}{\partial X} \frac{{\partial }^{2} X}{\partial {x}^{2}} \\ \frac{{\partial }^{2} \tilde{u} ( X , Z , t )}{\partial {z}^{2}} = \frac{{\partial }^{2} u ( X , Z , t )}{\partial {Z}^{2}} {( \frac{\partial Z}{\partial z} )}^{2} + \frac{\partial u ( X , Z , t )}{\partial Z} \frac{{\partial }^{2} Z}{\partial {z}^{2}} \qquad ( 4 )$$

If the logarithmic function is used as a new axis, the wave propagates along the logarithmic axis. Then a large modeling domain may be constructed without computational overburden. Exemplary new axes for 2-D may be defined as follow:

$$X = \{ \begin{matrix}log ( x + 1 ) & x \geq 0 \\ - log ( - x + 1 ) & x \leq 0\end{matrix} \\ Z = log ( z + 1 ) z \geq 0 \qquad ( 5 )$$

Then, a new 2-D waveform equation which provides modeling of wavelet propagating along logarithmic axes in a cosine transformation domain can be expressed as:

$$- \frac{{w}^{2}}{{c}^{2}} \tilde{u} ( X , Z , w ) = \frac{{\partial }^{2} \tilde{u} ( X , Z , w )}{\partial {X}^{2}} \frac{1}{{e}^{2 X}} - \frac{\partial u ( X , Z , w )}{\partial X} \frac{1}{{e}^{2 X}} + \frac{{\partial }^{2} \tilde{u} ( X , Z , w )}{\partial {Z}^{2}} \frac{1}{{e}^{2 Z}} + \tilde{f} ( X , Z , t ) ( x \geq 0 ) \\ - \frac{{w}^{2}}{{c}^{2}} \tilde{u} ( X , Z , w ) = \frac{{\partial }^{2} \tilde{u} ( X , Z , w )}{\partial {X}^{2}} \frac{1}{{e}^{- 2 X}} + \frac{\partial u ( X , Z , w )}{\partial X} \frac{1}{{e}^{- 2 X}} + \frac{{\partial }^{2} \tilde{u} ( X , Z , w )}{\partial {Z}^{2}} \frac{ }{ε} + \tilde{f} ( X , Z , t ) ( x \leq 0 ) \qquad ( 6 )$$

In one example, the seismic imaging system may further include an image output unit 500 to convert modeling parameters calculated in the subsurface structure estimating unit and outputting the converted image data. The image output unit 500 may convert modeling parameters, for example, velocity distribution or mass distribution, into an image file for the visible display of the parameters.

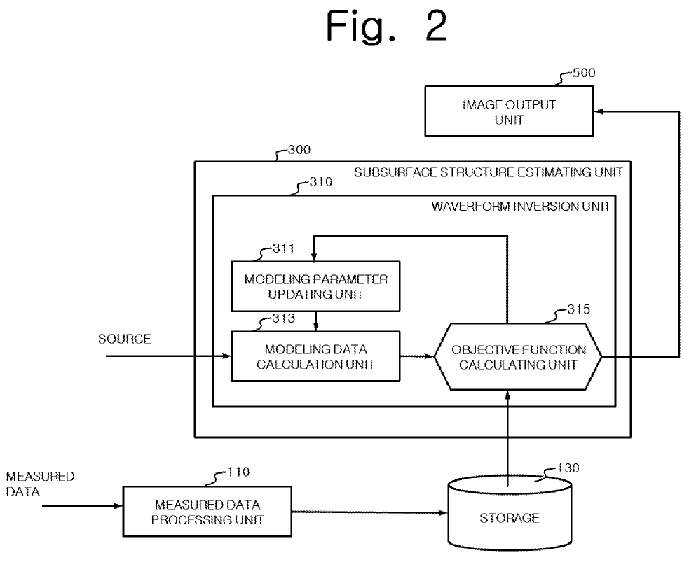

FIG. 2 is a block diagram illustrating an example of a seismic imaging system using waveform inversion according to an exemplary embodiment. Similar to the seismic imaging system illustrated in FIG. 1, the seismic imaging system of FIG. 2 includes a measured data processing unit 110 and a subsurface structure estimating unit 300. In one example, the subsurface structure estimating unit 300 may include a waveform inversion unit 310 to update initial modeling parameters of the cosine transformed acoustic waveform equation defined along logarithmic axes so as to minimize an objective function related to a residual between the measured data calculated in the measured data processing unit and modeling data calculated from a waveform equation with previous modeling parameters.

The waveform inversion unit may include a modeling data calculating unit 313 to calculate modeling data to be detected in each of receivers when a waveform propagates through subsurface structure defined by modeling parameters of a cosine transformed waveform equation defined along logarithmic scale axes, an objective function calculating unit 315 calculating an objective function related to a residual between measured data processed in the measured data processing unit 110 and modeling data processed in the modeling data computation unit 313, compare gradient of the objective function with a predetermined value and output the gradient if the gradient is larger than a predefined value and output the modeling parameters then if the gradient is smaller than the predefined value, and a modeling parameter updating unit 311 to update modeling parameters to a direction to which the objective function decreases and output the result to the modeling data calculating unit 313.

The seismic imaging system illustrated in FIG. 2 conforms to the general structure and operation of the conventional waveform inversion, except for the cosine transformation and logarithmic scale axes. Source estimation, gradient calculation, regularization and velocity update are similar to the conventional full-waveform inversion.

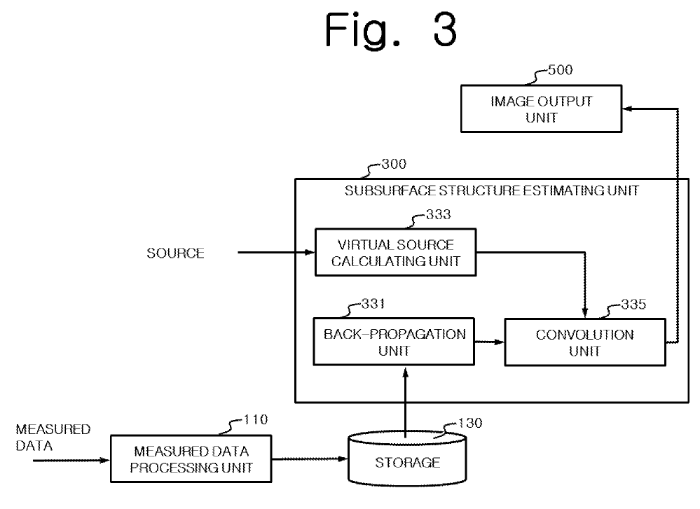

FIG. 3 is a block diagram illustrating an example of a seismic imaging system using reverse-time migration according to an exemplary embodiment. Referring to FIG. 3, a subsurface structure estimating unit 300 of the seismic imaging system includes a back-propagation unit 331 configured to back-propagate measured data converted by the measured data processing unit 110, based on a modeling parameter of a cosine transformed acoustic waveform equation defined along logarithmic-scaled axes, a virtual source estimator 333 configured to estimate virtual sources, and a convolution unit 335 configured to convolve the back-propagated measured data with the virtual source and to output the results of the convolution.

A reverse-time migration (RTM) using cosine transform and the axis transformation technique are suggested. The frequency domain RTM image can be written by using a Fourier transformation as follows:

$${Φ}_{k} = {\sum }_{s = 1}^{{N}_{s}} {\int }_{0}^{{ω}_{max}} Re ( {[ {u}_{s} ( ω ) ]}^{T} {d}_{s}^{*} ( r , ω ) ) d ω \\ {I}_{k} = \frac{\partial {Φ}_{k}}{\partial {p}_{k}} = {\sum }_{s = 1}^{{N}_{s}} {\int }_{0}^{{ω}_{max}} Re ( {[ \frac{\partial {u}_{s} ( ω )}{\partial {p}_{k}} ]}^{T} {d}_{s}^{*} ( r , ω ) ) d ω , \qquad 1 )$$

where ω is the angular frequency, uₛ and dₛ are the modeled and observed data in the frequency domain, * indicates the complex-conjugate, and T indicates the matrix transposition. In one example, the above equation may be resolved by back-propagation algorithm. Such method is similar to the conventional reverse-time migration.

Generally, reverse-time migration is applied to waveform inversion data so as to correct distortion, and therefore more accurate result can be obtained. Hence, the embodiment illustrated in FIG. 3 may be applied to the system illustrated in FIG. 2 in a recursive manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A seismic imaging system comprising:
a measured data processing unit converting measured data from receiver to cosine transformed data in logarithmic scale axes;
a subsurface structure estimating unit calculating subsurface modeling parameters with measured data transformed in the measured data processing unit based on a cosine transformed acoustic waveform equation defined along logarithmic axes; and
an image output unit converting modeling parameters calculated in the subsurface structure estimating unit and outputting the converted image data.

2. The seismic imaging system of claim 1, wherein the subsurface structure estimating unit comprises a waveform inversion unit updating initial modeling parameters of the cosine transformed acoustic waveform equation defined along logarithmic axes so as to minimize an objective function related to a residual between the measured data calculated in the measured data processing unit and modeling data calculated from a waveform equation with previous modeling parameters.

3. The seismic imaging system of claim 2, wherein the waveform inversion unit comprises:
a modeling data calculating unit calculating modeling data to be detected in each of receivers when a waveform propagates through subsurface structure defined by modeling parameters of cosine transformed waveform equation defined along logarithmic scale axes,
an objective function calculating unit calculating an objective function related to a residual between measured data processed in the measured data processing unit and modeling data processed in the modeling data computation unit, comparing gradient of the objective function with a predetermined value and outputting the gradient if the gradient is larger than a predefined value and outputting the modeling parameters then if the gradient is smaller than the predefined value and
a modeling parameter updating unit updating modeling parameters to a direction to which the objective function decreases and outputting the result to the modeling data calculating unit.

4. The seismic imaging system of claim 1, wherein the subsurface structure estimating unit comprises:
a back-propagation unit configured to back-propagate the measured data based on a modeling parameter of a cosine transformed acoustic waveform equation defined along logarithmic-scaled axes,
a virtual source estimator configured to estimate virtual sources and
a convolution unit configured to convolve the back-propagated measured data with the virtual source and to output the results of the convolution.

5. The seismic imaging system of claim 1, further comprising:
a back-propagation unit configured to back-propagate the measured data based on a modeling parameter of a cosine transformed acoustic waveform equation defined along logarithmic-scaled axes;
a virtual source estimator configured to estimate virtual sources; and
a convolution unit configured to convolve the back-propagated measured data with the virtual source and to output the results of the convolution.
